(19) United States
(12) Patent Application Publication
(10) Pub. No.: US 2026/0303223 A1
(43) Pub. Date: Oct. 1, 2026

(54) SIGNAL ESTIMATION APPARATUS, SIGNAL ESTIMATION METHOD, AND NON-TRANSITORY RECORDING MEDIUM

(71) Applicant: NEC Corporation, Tokyo (JP)

(72) Inventor: Norifumi KAMIYA, Tokyo (JP)

(73) Assignee: NEC Corporation, Tokyo (JP)

(21) Appl. No.: 19/477,126

(22) PCT Filed: May 18, 2023
(86) PCT No.: PCT/JP2023/018589

§ 371 Date: Oct. 21, 2025

(51) Int. Cl. H04B 10/61

(52) U.S. Cl. CPC H04B 10/616

(57) ABSTRACT

A signal estimation apparatus includes a plurality of signal estimation units, each of which includes two linear equalizers and one non-linear converter. The plurality of signal estimation units is connected in series so that the output signal generated by the r-1th signal estimation unit is input to the rth signal estimation unit connected subsequent to the r-1th signal estimation unit. The rth signal estimation unit generates an output signal from the output signal generated by the r-1-th signal estimation unit and a plurality of received signals using the two linear equalizers and the non-linear transformer.

### TECHNICAL FIELD

The present invention relates to a signal estimation apparatus, a signal estimation method, and a recording medium capable of estimating a plurality of transmitted signals corresponding to a plurality of received signals from a plurality of spatially multiplexed received signals.

### BACKGROUND ART

Research is being conducted on a transmission system that uses a multi-core optical fiber containing multiple cores to transmit a plurality of spatially multiplexed transmitted signals from a transmitting apparatus to a receiving apparatus. In such a transmission system, the receiving apparatus that receives the spatially multiplexed plurality of transmitted signals as spatially multiplexed plurality of received signals performs signal estimation processing to estimate the plurality of transmitted signals from the plurality of received signals (specifically, MIMO (Multi-Input Multi-Output) equalization processing).

As an example of signal estimation processing, signal estimation processing using a plurality of linear equalizers can be cited. In this case, the filter coefficients (tap coefficients) of each linear equalizer are optimized such that the error between the estimated results of the plurality of transmitted signals obtained through signal estimation processing and the actual transmitted plurality of transmitted signals is minimized. For example, in Non-Patent Documents 1 and 2, a linear equalizer is used to estimate a plurality of transmitted signals by optimizing the filter coefficients (tap coefficients) so that the minimum mean square error between the estimated results of plurality of transmitted signals obtained through signal estimation processing and the actual transmitted plurality of transmitted signals is minimized. This is described as an example of MMSE (Minimum Mean Square Error) estimation processing, which uses a linear equalizer to estimate multiple transmitted signals by optimizing filter coefficients (tap coefficients) such that the least squares error between the estimated results of multiple transmitted signals obtained through signal estimation processing and the actual transmitted plurality of transmitted signals is minimized, is described as an example of signal estimation processing.

### CITATION LIST

### Non-Patent Literature

Non-patent Literature 1: Peter J. Winzer et al., “MIMO capacities and outage probabilities in spatially multiplexed optical transport systems”, Opt. Express, vol. 19, no. 17, pp. 16680-16696, August 2011
Non-patent Literature 2: K. Shibahara et al., “Advanced MIMO signal processing techniques enabling Long-Haul Dense SDM transmissions”, Journal of Lightwave Technology, vol. 36, no. 2, pp. 336-348, January 2018

### SUMMARY

Although the MMSE estimation process has the advantage of reducing computational cost, it has the technical issue of room for improvement in the estimation accuracy of plurality of transmitted signals.

Furthermore, similar technical issues may arise not only in transmission systems that transmit plurality of transmitted signals using multi-core optical fibers but also in transmission systems that transmit plurality of transmitted signals using radio waves (i.e., wireless communication systems).

The present invention aims to provide a signal estimation apparatus, a signal estimation method, and a recording medium capable of solving the above-mentioned technical problems. As an example, the present invention aims to provide a signal estimation apparatus, a signal estimation method, and a recording medium capable of improving the estimation accuracy of plurality of transmitted signals.

### Solution to Problem

One example embodiment of the signal estimation apparatus that estimates a plurality of transmitted signals respectively corresponding to a plurality of received signals that are spatially multiplexed, from the plurality of received signals, the signal estimation apparatus including a plurality of signal estimation units, each of the plurality of signal estimation units includes two linear equalizers and one nonlinear transformer that performs nonlinear transformation, the plurality of signal estimation units being connected in series such that output signals generated by a r-1th signal estimation unit (here, r is a variable indicating an integer greater than or equal to 2 and less than or equal to the number of the plurality of signal estimation units) using the two linear equalizers and the nonlinear transformer provided in the r-1th signal estimation unit is input to a rth signal estimation unit connected subsequent to the r-1th signal estimation unit, and the rth signal estimation unit generates output signals using the two linear equalizers and the nonlinear transformer provided in the rth signal estimation unit, from the plurality of received signals and the output signals generated by the r-1th signal estimation unit using the two linear equalizers and the nonlinear transformer provided in the r-1th signal estimation unit.

One example embodiment of the signal estimation method for estimating a plurality of transmitted signals respectively corresponding to a plurality of received signals that are spatially multiplexed, from the plurality of received signals, the signal estimation method including: inputting the plurality of received signals; and estimating the plurality of transmitted signals from the plurality of received signals using a plurality of signal estimation units connected in series, each of the plurality of signal estimation units including two linear equalizers and one nonlinear transformer that performs nonlinear transformation, and the estimating the plurality of transmitted signals includes: inputting output signals generated by a i-1th signal estimation unit (here, i is a variable indicating an integer equal to or greater than 2 and less than the number of signal estimation units) using the two linear equalizers and the nonlinear transformer provided in the i-1th signal estimation unit to a ith signal estimation unit connected subsequent to the i-1th signal estimation unit; and generating output signals to be output by the ith signal estimation unit by using the two linear equalizers and the nonlinear transformer provided in the ith signal estimation unit, from the plurality of received signals and the output signals generated by the i-1-th signal estimation unit using the two linear equalizers and the nonlinear transformer provided in the i-1-th signal estimation unit.

One example embodiment of the recording medium on which a computer program is stored, the computer program being configured to allow a computer to execute a signal estimation method for estimating a plurality of transmitted signals respectively corresponding to a plurality of received signals that are spatially multiplexed, from the plurality of received signals, the signal estimation method including: inputting the plurality of received signals; and estimating the plurality of transmitted signals from the plurality of received signals using a plurality of signal estimation units connected in series, each of the plurality of signal estimation units including two linear equalizers and one nonlinear transformer that performs nonlinear transformation, and the estimating the plurality of transmitted signals includes: inputting output signals generated by a i-1th signal estimation unit (here, i is a variable indicating an integer equal to or greater than 2 and less than the number of signal estimation units) using the two linear equalizers and the nonlinear transformer provided in the i-1th signal estimation unit to a ith signal estimation unit connected subsequent to the i-1th signal estimation unit; and generating output signals to be output by the ith signal estimation unit by using the two linear equalizers and the nonlinear transformer provided in the ith signal estimation unit, from the plurality of received signals and the output signals generated by the i-1-th signal estimation unit using the two linear equalizers and the nonlinear transformer provided in the i-1-th signal estimation unit.

According to the signal estimation apparatus, signal estimation method, and recording medium described above, the estimation accuracy of plurality of transmitted signals can be improved.

### BRIEF DESCRIPTION OF DRAWINGS

FIG. 1 is a block diagram showing the configuration of the transmission system according to this example embodiment.

FIG. 2 is a block diagram showing the configuration of a receiving apparatus that performs MIMO equalization processing.

FIG. 3 is a block diagram showing the configuration of a MIMO equalizer.

FIG. 4 is a flowchart showing the flow of MIMO equalization processing.

FIG. 5 is a block diagram showing the configuration of a nonlinear transformer.

FIG. 6 is a graph showing the relationship between input and output in an activation function.

FIG. 7 is a graph showing the bit error rate of the estimated signal.

FIG. 8 is a block diagram showing the configuration of the coefficient update apparatus.

FIG. 9 is a block diagram showing the configuration of the coefficient update error propagation unit.

FIG. 10 is a flowchart showing the flow of the coefficient update operation.

FIG. 11 is a flowchart showing a modified example of the coefficient update operation.

### DESCRIPTION OF EXAMPLE EMBODIMENTS

With reference to the drawings, the signal estimation apparatus, signal estimation method, and recording medium example embodiment applied to the transmission system SYS will be described. However, the present invention is not limited to the example embodiments described below.

### <1> Configuration of Transmission System SYS

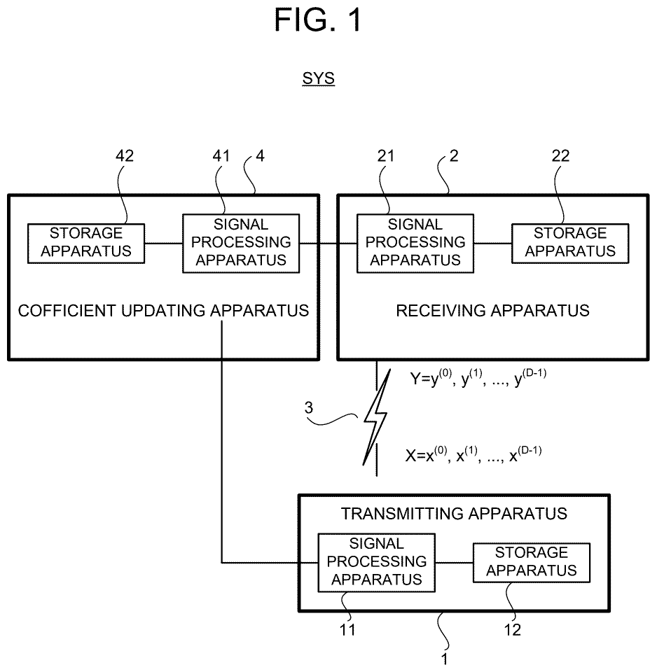

First, with reference to FIG. 1, the overall configuration of the transmission system SYS in this example embodiment will be described. FIG. 1 is a block diagram showing the configuration of the transmission system SYS in this example embodiment.

As shown in FIG. 1, the transmission system SYS includes a transmitting apparatus 1 and a receiving apparatus 2. The transmitting apparatus 1 transmits a MIMO (Multi-Input Multi-Output) transmitted signal X, which includes a plurality of transmitted signals x that are spatially multiplexed, to the receiving apparatus 2 via a transmission path 3. The receiving apparatus 2 receives the MIMO transmitted signal X transmitted from transmitting apparatus 1 via the transmission path 3 as a MIMO received signal Y. In other words, the receiving apparatus 2 receives the plurality of transmitted signals x transmitted from the transmitting apparatus 1 via the transmission path 3 as a plurality of received signals y. Note that each transmitted signal x may include a plurality of signal components, and therefore may be referred to as a transmitted signal sequence. Similarly, each received signal y may include a plurality of signal components, and therefore may be referred to as a received signal sequence.

The following description explains an example where the multiplexing number of MIMO transmitted signal X and the MIMO received signal Y is D (where D is a variable representing an integer of 2 or more). In this case, the transmitting apparatus 1 transmits the MIMO transmitted signal X containing D spatially multiplexed transmitting signal x⁽⁰⁾ to x^{(D-1)} to the receiving apparatus 2 via the transmission path 3. The receiving apparatus 2 receives D transmitted signals x⁽⁰⁾ to x^{(D-1)} transmitted from the transmitting apparatus 1 via the transmission path 3 as D spatially multiplexed received signals y⁽⁰⁾ to y^{(D-1)}.

In order to transmit the plurality of transmitted signals x⁽⁰⁾ to x^{(D-1)}, the transmitting apparatus 1 is equipped with a signal processing apparatus 11 and a storage apparatus 12.

The signal processing apparatus 11 includes a CPU (Central Processing Unit). a GPU (Graphic Processing Unit), and/or an FPGA (Field Programmable Gate Array). The signal processing apparatus 11 may read a computer program. For example, the signal processing apparatus 11 may read a computer program stored in the storage apparatus 12. For example, the signal processing apparatus 11 may read a computer program stored in a computer-readable recording medium using a recording medium reading apparatus not shown. The signal processing apparatus 11 may obtain a computer program from an unillustrated apparatus located outside the transmitting apparatus 1 via an unillustrated communication apparatus (i.e., it may download or read the program). The signal processing apparatus 11 executes the read computer program. As a result, logical functional blocks for executing the operations to be performed by the transmitting apparatus 1 are realized within the signal processing apparatus 11. Specifically, within signal processing apparatus 11, logical functional blocks for executing transmission operations that transmit the transmitted signals x⁽⁰⁾ to x^{(D-1)} are realized. In other words, the signal processing apparatus 11 can function as a controller for realizing logical functional blocks for executing operations that the transmitting apparatus 1 should perform.

The storage apparatus 12 is capable of storing desired data. For example, the storage apparatus 12 may temporarily store the computer program executed by signal processing apparatus 11. The storage apparatus 12 may temporarily store data that the signal processing apparatus 11 temporarily uses while executing a computer program. The storage apparatus 12 may store data that the transmitting apparatus 1 is to store long-term. Note that the storage apparatus 12 may be a RAM (Random Access Memory), ROM (Read Only Memory), a hard disk apparatus, an optical magnetic disk apparatus, an SSD (Solid State Drive), and a disk array apparatus.

In order to receive the plurality of received signals y⁽⁰⁾ to y^{(D-1)}, the receiving apparatus 2 is equipped with a signal processing apparatus 21 and a storage apparatus 22.

The signal processing apparatus 21 includes a CPU (Central Processing Unit), a GPU (Graphic Processing Unit), and/or an FPGA (Field Programmable Gate Array). The signal processing apparatus 21 may read a computer program. For example, the signal processing apparatus 21 may read a computer program stored in the storage apparatus 22. For example, the signal processing apparatus 21 may read a computer program stored in a computer-readable recording medium using a recording medium reading apparatus not shown. The signal processing apparatus 21 may obtain a computer program from an unillustrated apparatus located outside the receiving apparatus 2 via an unillustrated communication apparatus (i.e., it may download or read the program). The signal processing apparatus 21 executes the read computer program. As a result, logical functional blocks for executing the operations to be performed by the receiving apparatus 2 are realized within the signal processing apparatus 21. Specifically, within signal processing apparatus 21, logical functional blocks for performing the reception operation of receiving the plurality of received signals y⁽⁰⁾ to y^{(D-1)} are realized. In other words, the signal processing apparatus 21 is capable of functioning as a controller for realizing logical functional blocks for performing the operations that the receiving apparatus 2 should perform.

The storage apparatus 22 is capable of storing desired data. For example, the storage apparatus 22 may temporarily store a computer program executed by the signal processing apparatus 21. The storage apparatus 22 may temporarily store data that the signal processing apparatus 21 temporarily uses while executing a computer program. The storage apparatus 22 may store data that the receiving apparatus 2 is to store long-term. Note that the storage apparatus 22 may be a RAM (Random Access Memory), ROM (Read-Only Memory), a hard disk apparatus, an optical magnetic disk apparatus, an SSD (Solid State Drive), and a disk array apparatus.

The transmission path 3 may include a wired transmission path realized by a wired communication cable. For example, the transmission path 3 may include a wired transmission path including a multi-core optical fiber including multiple cores. In this case, crosstalk (XT: Cross Talk) between plurality of the transmitted signals x transmitted through each of the multiple cores may be allowed. In other words, interference between the plurality of transmitted signals x transmitted via multiple cores may be permitted. In this case, the transmission capacity can be increased compared to in a case where crosstalk is not permitted. Alternatively, the transmission path 3 may include a wireless transmission path realized by wireless radio waves in addition to or instead of the wired transmission path.

In the following description, regardless of whether the transmission path 3 includes a wireless transmission path or not, the transmitting apparatus 1 transmits the MIMO transmitted signals X (i.e., the spatially multiplexed plurality of transmitted signals x) to the receiving apparatus 2, and the receiving apparatus 2 receives the MIMO received signals Y (i.e., the spatially multiplexed plurality of signals y) from the wireless transmission path 3. In other words, in this example embodiment, the MIMO transmission technology is not limited to transmission technology performed in a case where the transmission path 3 includes a wireless transmission path.

The receiving apparatus 2 performs signal estimation processing (i.e., signal equalization processing) to estimate the plurality of transmitted signals x⁽⁰⁾ to x^{(D-1)} from the plurality of received signals y⁽⁰⁾ to y^{(D-1)} as at least apart of the receiving operation. Note that in the following description, the signal estimation process that estimates the plurality of transmitted signals x⁽⁰⁾ to x^{(D-1)} from the plurality of received signals y⁽⁰⁾ to y^{(D-1)} is referred to as MIMO equalization processing.

Specifically, the relationship between the plurality of received signals y⁽⁰⁾ to y^{(D-1)} and the plurality of transmitted signals x⁽⁰⁾ to x^{(D-1)} is expressed by formula 1. Note that k in formula 1 is a variable representing an integer of 1 or more and D-1 or less. m in formula 1 is a variable representing an integer of 1 or more and D-1 or less. In formula 1, h^{(k, m)} denotes the impulse response of each of the D×D transmission paths formed between the transmitting apparatus 1 and the receiving apparatus 2. In formula 1, z^{(k)} denotes the white noise component. In formula 1, the symbol “[conv]” denotes the convolution operator. In the following description, the symbol “[conv]” also denotes the convolution operation as an operator. Therefore, in the following description, “A[conv]B” denotes the convolution operation between A and B. The receiving apparatus 2 may perform signal estimation processing based on the assumption that the relationship between the plurality of received signals y⁽⁰⁾ to y^{(D-1)} and the plurality of transmitted signals x⁽⁰⁾ to x^{(D-1)} is represented by formula 1.

$${y}^{( k )} = {\sum }_{m = 0}^{D - 1} ( {h}^{( k , m )} [ conv ] {x}^{( m )} ) + {z}^{( k )} , k = 0 , 1 … , D - 1 \qquad [ Formula 1 ]$$

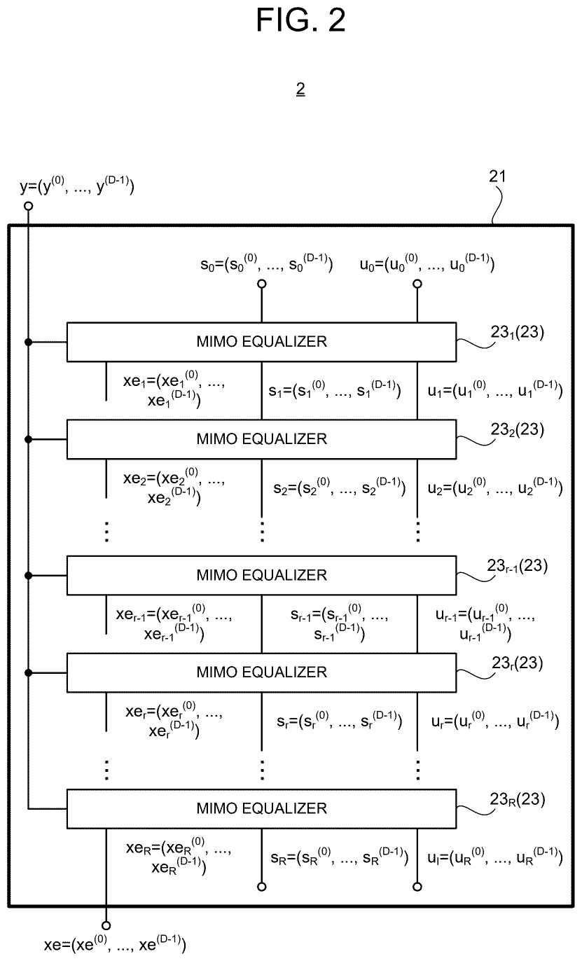

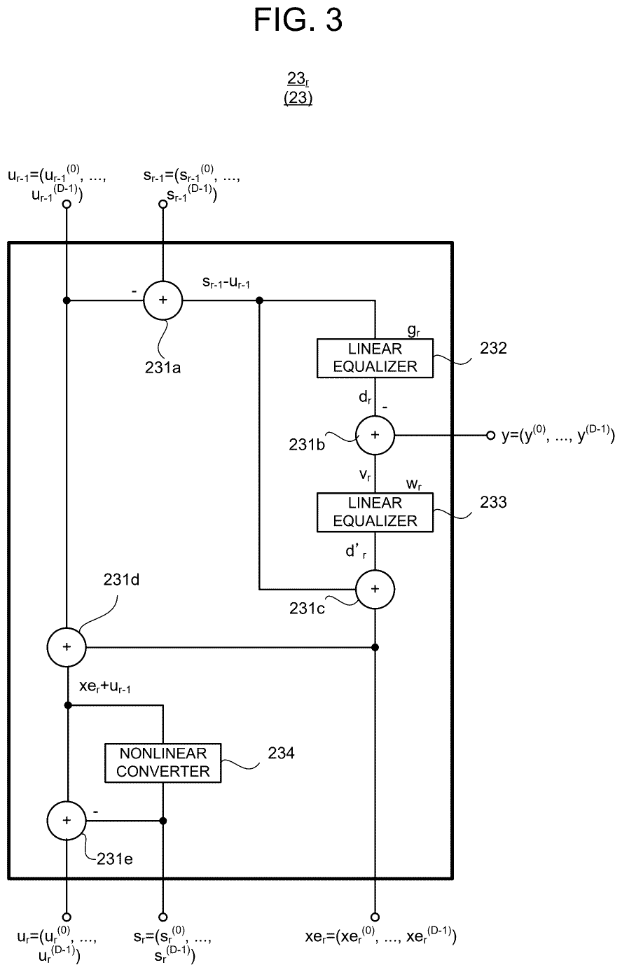

The receiving apparatus 2 performs MIMO equalization processing using a plurality of MIMO equalizers 23 (see FIG. 2) as described in detail later. Note that the MIMO equalizer 23 may also be referred to as signal equalizer, signal estimator, signal equalization unit, or signal estimation unit. In this example embodiment, the MIMO equalizer 23, as will be described in detail later, includes two linear equalizers 232 and 233 and one nonlinear transformer 234 (see FIG. 3). In this case, as will be described in detail later, the receiving apparatus 2 can improve the estimation accuracy of the plurality of transmitted signals x⁽⁰⁾ to x^{(D-1)}.

The transmission system SYS further includes a coefficient update apparatus 4. The coefficient update apparatus 4 performs coefficient update operations to update (i.e., set) the filter coefficients (tap coefficients) g of the linear equalizer 232 and the filter coefficients (tap coefficients) w of the linear equalizer 233. Details of the coefficient update operations will be described later.

To perform the coefficient update operation, the coefficient update apparatus 4 includes a signal processing apparatus 41 and a storage apparatus 42.

The signal processing apparatus 41 includes a CPU (Central Processing Unit), a GPU (Graphics Processing Unit), and/or an FPGA (Field Programmable Gate Array). The signal processing apparatus 41 may read a computer program. For example, the signal processing apparatus 41 may read a computer program stored in the storage apparatus 42. For example, the signal processing apparatus 41 may read a computer program stored in a computer-readable recording medium using a recording medium reading apparatus not shown. The signal processing apparatus 41 may obtain a computer program from an unillustrated apparatus located outside the receiving apparatus 2 via an unillustrated communication apparatus (i.e., it may download or read the program). The signal processing apparatus 41 executes the read computer program. As a result, logical functional blocks for executing the operations to be performed by the receiving apparatus 2 are realized within the signal processing apparatus 41. Specifically, within signal processing apparatus 41, logical functional blocks for performing the reception operation of receiving the plurality of received signals y⁽⁰⁾ to y^{(D-1)} are realized. In other words, signal processing apparatus 41 is capable of functioning as a controller for realizing logical functional blocks for performing the operations that receiving apparatus 2 should perform.

The storage apparatus 42 is capable of storing desired data. For example, the storage apparatus 42 may temporarily store a computer program executed by the signal processing apparatus 41. The storage apparatus 42 may temporarily store data temporarily used by the signal processing apparatus 41 in a case where the signal processing apparatus 41 is executing the computer program. The storage apparatus 42 may store data that the receiving apparatus 2 stores for long-term storage. Note that the storage apparatus 42 may include at least one of RAM (Random Access Memory), ROM (Read Only Memory), a hard disk apparatus, an optical magnetic disk apparatus, an SSD (Solid State Drive), and a disk array apparatus.

### <2> MIMO Equalization Processing Performed by the Receiving Apparatus 2

Next, the MIMO equalization processing performed by the receiving apparatus 2 will be described.

### <2-1> Configuration of the Receiving Apparatus 2 (Signal Processing Apparatus 21)

First, with reference to FIG. 2, the configuration of the receiving apparatus 2 that performs MIMO equalization processing (in particular, the configuration of the signal processing apparatus 21) will be described. FIG. 2 is a block diagram showing the logical functional blocks realized in the signal processing apparatus 21 for performing MIMO equalization processing.

As shown in FIG. 2, the signal processing apparatus 21 includes the plurality of MIMO equalizers 23 as logical functional blocks for performing MIMO equalization processing. Note that FIG. 2 merely shows the logical functional blocks for performing MIMO equalization processing in a conceptual (i.e., simplified) manner. In other words, the functional blocks shown in FIG. 2 do not necessarily need to be implemented as they are in the signal processing apparatus 21. As long as the signal processing apparatus 21 can perform the MIMO equalization processing performed by the functional blocks shown in FIG. 2, the configuration of the functional blocks implemented in the signal processing apparatus 21 is not limited to the configuration shown in FIG. 2.

The plurality of MIMO equalizers 23 are connected in series (or, in other words, coupled in series). Specifically, the plurality of MIMO equalizers 23 are connected in series such that the output of one MIMO equalizer 23 is input to another MIMO equalizer 23 connected downstream of the MIMO equalizer 23. The following description explains an example in which the signal processing apparatus 21 includes R (where R is a constant representing an integer of 2 or more) MIMO equalizers 23.

In the following description, the rth (where r is a variable representing an integer of 1 or more and less than or equal to R) MIMO equalizer 23 among the R MIMO equalizers 23 is referred to as MIMO equalizer 23ᵣ. In this case, the signal processing apparatus 21 includes MIMO equalizers 23₁, MIMO equalizers 23₂, . . . , MIMO equalizers 23ᵣ₋₁, MIMO equalizers 23ᵣ, . . . , MIMO equalizers 23_{R-1}, and MIMO equalizers 23_{R}. Furthermore, in a case where the variable r indicates an integer of 2 or more, the R MIMO equalizers 23₁ to 23_{R} are connected in series such that the output of the MIMO equalizer 23ᵣ₋₁ is input to the MIMO equalizer 23ᵣ connected downstream of the MIMO equalizer 23ᵣ₋₁.

The MIMO equalizer 23ᵣ temporarily estimates the plurality of transmitted signals x (i.e., the plurality of transmitted signals x⁽⁰⁾ to x^{(D-1)}) corresponding to the plurality of received signals y (i.e., the plurality of received signals y⁽⁰⁾ to y^{(D-1)}. Note that in the following description, the provisional estimation results of the plurality of transmitted signals x by the MIMO equalizer 23ᵣ are referred to as plurality of estimated signals xₑᵣ. That is, in the following description, the provisional estimation results of the plurality of transmitted signals x⁽⁰⁾ to x^{(D-1)} by the MIMO equalizer 23ᵣ are referred to as the estimated signals xᵣ⁽⁰⁾ to xᵣ^{(D-1)}, respectively. Therefore, the MIMO equalizer 23ᵣ generates plurality of estimated signals xₑᵣ from the plurality of received signals y.

The MIMO equalizer 23ᵣ further generates auxiliary signals s and u. In the following description, the auxiliary signals s and u generated by the MIMO equalizer 23ᵣ are referred to as auxiliary signals sᵣ and uᵣ, respectively. The auxiliary signal sᵣ includes plurality of (specifically, D) auxiliary signals sᵣ⁽⁰⁾ to sᵣ^{(D-1)}. The auxiliary signal uᵣ includes plurality of (specifically, D) auxiliary signals uᵣ⁽⁰⁾ to uᵣ^{(D-1)}.

The MIMO equalizer 23ᵣ generates plurality of estimated signals xeᵣ, auxiliary signal sᵣ, and auxiliary signal uᵣ from plurality of received signals y, auxiliary signals sᵣ₋₁ generated by the MIMO equalizer 23ᵣ₋₁, and auxiliary signals uᵣ₋₁ generated by the MIMO equalizer 23ᵣ₋₁. For this purpose, MIMO equalizer 23ᵣ₋₁ outputs auxiliary signal sᵣ₋₁ and auxiliary signal uᵣ₋₁ to MIMO equalizer 23ᵣ. However, in a case where the variable r is 1, since there is no MIMO equalizer 23₀ connected to the front end of MIMO equalizer 23₁, MIMO equalizer 23₁ receives plurality of received signals y and auxiliary signal so corresponding to the initial values of auxiliary signals s (specifically, plurality of auxiliary signals s₀⁽⁰⁾ to s₀^{(D-1)}) and, auxiliary signal u₀ corresponding to the initial value of auxiliary signal u (specifically, plurality of auxiliary signals u₀⁽⁰⁾ to u₀^{(D-1)}), to generate plurality of estimated signals xe₁, auxiliary signal s₁, and auxiliary signal u₁.

The signal processing apparatus 21 outputs the plurality of estimated signals xe_{R}⁽⁰⁾ to xe_{R}^{(D-1)} generated by the Rth MIMO equalizer 23_{R} as the final estimated results of the plurality of transmitted signals x⁽⁰⁾ to x^{(D-1)} corresponding to the plurality of received signals y⁽⁰⁾ to y^{(D-1)}, respectively. In other words, the signal processing apparatus 21 outputs the plurality of estimated signals xe_{R}⁽⁰⁾ to xe_{R}^{(D-1)} generated by the Rth MIMO equalizer 23_{R} as the final estimated results of the plurality of transmitted signals x⁽⁰⁾ to x^{(D-1)}.

An example of the configuration of MIMO equalizer 23ᵣ (i.e., the configuration of each of MIMO equalizers 23₁ to 23_{R}) is shown in FIG. 3. As shown in FIG. 3, the MIMO equalizer 23ᵣ includes a linear equalizer 232, a linear equalizer 233, and a nonlinear transformer 234. Therefore, the MIMO equalizer 23ᵣ uses two linear equalizers 232 and 233 and one nonlinear transformer 234 to generate plurality of the estimated signals xeᵣ, the auxiliary signal sᵣ, and the auxiliary signal uᵣ from the plurality of received signals y, the auxiliary signal sᵣ₋₁, and the auxiliary signal uᵣ₋₁. Furthermore, the MIMO equalizer 23ᵣ includes adders 231a, 231b, 231c, 231d, and 231e.

### <2-2> MIMO Equalization Processing Flow

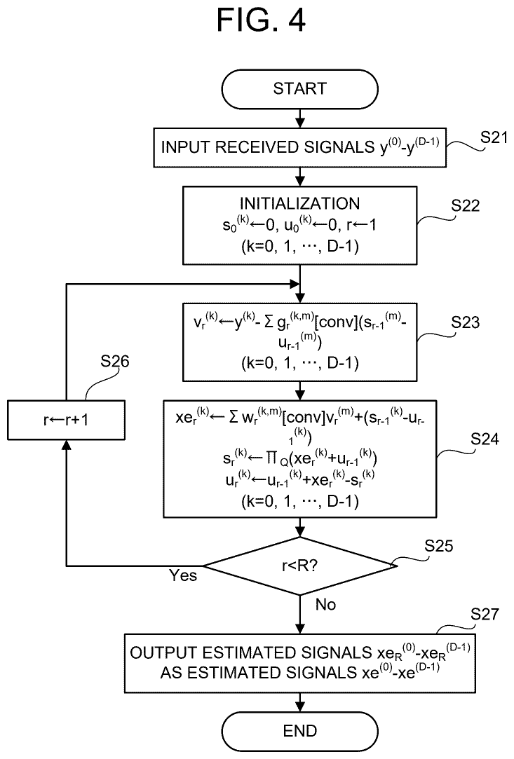

Next, with reference to FIG. 2 and FIG. 3 and FIG. 4, the MIMO equalization processing performed by the receiving apparatus 2 using the plurality of MIMO equalizers 23 will be described. FIG. 4 is a flowchart showing the MIMO equalization processing flow.

As shown in FIG. 4, the plurality of received signals y (the plurality of received signals y⁽⁰⁾ to y^{(D-1)}) received by the receiving apparatus 2 are input to the signal processing apparatus 21 of the receiving apparatus 2 (step S21).

Furthermore, the signal processing apparatus 21 performs an initialization process (step S22). Specifically, the signal processing apparatus 21 initializes the auxiliary signals so (the plurality of auxiliary signals s₀⁽⁰⁾ to s₀^{(D-1)}) to zero. Furthermore, the signal processing apparatus 21 initializes the auxiliary signals u₀ (the plurality of auxiliary signals u₀⁽⁰⁾ to u₀^{(D-1)}) to zero. Furthermore, the signal processing apparatus 21 initializes the variable r to 1.

Then, the MIMO equalizer 23ᵣ generates a difference signal yr using the linear equalizer 232 (step S23). Specifically, the MIMO equalizer 23ᵣ generates a difference signal (sᵣ₋₁−uᵣ₋₁) corresponding to the difference between the auxiliary signal sᵣ₋₁ and the auxiliary signal uᵣ₋₁ using the adder 231a. Then, the MIMO equalizer 23ᵣ uses the linear equalizer 232 to perform a convolution operation between the difference signal (sᵣ₋₁−uᵣ₋₁) and the filter coefficient gᵣ of the linear equalizer 232 provided by the MIMO equalizer 23ᵣ, thereby generating the convolution signal dᵣ. In other words, the linear equalizer 232 performs a convolution operation to generate the convolution signal dᵣ as a filter process using the auxiliary signals sᵣ₋₁ and uᵣ₋₁. The filter coefficients gr are a filter coefficient vector including D×D filter coefficients gᵣ^{(0, 0)} to gᵣ^{(D-1, D-1)}. The filter coefficients gᵣ^{(0, 0)} to gᵣ^{(D-1, D-1)} are updated (set) by the coefficient update apparatus 4 as described later. The convolution signal dᵣ includes D convolution signals dᵣ⁽⁰⁾ to dᵣ^{(D-1)}. In this case, the MIMO equalizer 23ᵣ may perform the convolution operation shown in formula 2. The symbol “←” in formula 2 indicates the operation of substituting the right-hand side into the left-hand side. In the following description, the symbol “←” also indicates the operation of substituting the right side for the left side. Subsequently, the MIMO equalizer 23ᵣ generates a difference signal vᵣ corresponding to the difference between the convolved signal dᵣ output by the linear equalizer 232 and the plurality of received signals y using the adder 231b. Specifically, the MIMO equalizer 23ᵣ repeats the process of generating a difference signal vᵣ^{(k)} corresponding to the difference between the convolved signal dᵣ^{(k)} and the received signal y^{(k)} using the adder 231b, while varying the variable k from 0 to D-1, thereby generating D difference signals vᵣ⁽⁰⁾ to vᵣ^{(D-1)}. In other words, the MIMO equalizer 23ᵣ generates D differential signals vᵣ⁽⁰⁾ to vᵣ^{(D-1)} by performing the operation shown in formula 3.

$${d}_{r}^{( k )} ← {\sum }_{m = 0}^{D - 1} ( {g}_{r}^{( k , m )} [ conv ] ( {s}_{r - 1}^{( k )} - {u}_{r - 1}^{( k )} ) ) , k = 0 , 1 … , D - 1 \qquad [ Formula 2 ]$$

$${v}_{r}^{( k )} ← {y}^{( k )} - {d}_{r}^{( k )} , k = 0 , 1 … , D - 1 \qquad [ Formula 3 ]$$

Subsequently, the MIMO equalizer 23ᵣ generates an estimated signal xᵣ using the linear equalizer 233 (Step S24). Specifically, the MIMO equalizer 23ᵣ generates a convolution signal d′ᵣ by performing a convolution operation between the difference signal yᵣ and the filter coefficients wᵣ of the linear equalizer 233 provided in the MIMO equalizer 23ᵣ. In other words, the linear equalizer 233 performs a convolution operation to generate the convolution signal d′ᵣ as a filter process using the difference signal vᵣ (i.e., a filter process using the convolution signal dᵣ, which is the output of the linear equalizer 232, and the plurality of received signals y). The filter coefficients wᵣ is a filter coefficient vector containing D×D filter coefficient wᵣ^{(0, 0)} to wᵣ^{(D-1, D-1)}. The filter coefficients wᵣ^{(0, 0)} to wᵣ^{(D-1, D-1)} are updated (set) by the coefficient update apparatus 4 as described later. The convolution signal d′ᵣ includes D convolution signals d′ᵣ⁽⁰⁾to d′ᵣ^{(D-1)}. In this case, the MIMO equalizer 23ᵣ may perform the convolution operation shown in formula 4. Subsequently, the MIMO equalizer 23ᵣ generates an estimated signal xᵣ by adding the convolved signal dᵣ output from the linear equalizer 232 and the difference signal (sᵣ₋₁−uᵣ₋₁) generated by the adder 231a using the adder 231c. Specifically, the MIMO equalizer 23r repeats the process of adding the convolved signal d′ᵣ^{(k)} and the difference signal (sᵣ₋₁^{(k)}−uᵣ₋₁^{(k)}) using the adder 231b while varying the variable k from 0 to D-1, thereby generating plurality of estimated signals xᵣ⁽⁰⁾ to xᵣ^{(D-1)}. In other words, the MIMO equalizer 23ᵣ generates plurality of estimated signals xeᵣ⁽⁰⁾to xeᵣ^{(D-1)} by performing the operation shown in formula 5.

$${d}_{r}^{′ ( k )} ← {\sum }_{m = 0}^{D - 1} ( {w}_{r}^{( k , m )} [ conv ] {v}_{r}^{( k )} ) , k = 0 , 1 … , D - 1 \qquad [ Formula 4 ]$$

$${xe}_{r}^{( k )} ← {d}_{r}^{′ ( k )} + ( {s}_{r - 1}^{( k )} - {u}_{r - 1}^{( k )} ) , k = 01 , … , D - 1 \qquad [ Formula 5 ]$$

Furthermore, the MIMO equalizer 23ᵣ generates the auxiliary signal sᵣ using the nonlinear transformer 234 (step S24). Specifically, the MIMO equalizer 23ᵣ uses the adder 231d to add the plurality of estimated signals xeᵣ generated by the MIMO equalizer 23ᵣ and the auxiliary signal uᵣ₋₁ input from the MIMO equalizer 23ᵣ₋₁, thereby generating an added signal (xeᵣ+uᵣ₋₁). Specifically, the MIMO equalizer 23ᵣ uses the adder 231d to add the estimated signal xeᵣ^{(k)} and the auxiliary signal uᵣ₋₁^{(k)}, repeating this process while varying the variable k from 0 to D-1, thereby generating plurality of sum signals (xeᵣ(k)+uᵣ₋₁^{(k)}). Then, the MIMO equalizer 23ᵣ generates an auxiliary signal sᵣ by performing a nonlinear transformation process on the sum signal (xeᵣ+uᵣ₋₁) using the nonlinear transformer 234. Specifically, the MIMO equalizer 23ᵣ generates an auxiliary signal sᵣ by performing a nonlinear transformation process on the sum signal (xeᵣ(k)+uᵣ₋₁^{(k)}) to generate an auxiliary signal sᵣ^{(k)}. This process is repeated while varying the variable k from 0 to D-1, thereby generating plurality of auxiliary signals sᵣ⁽⁰⁾ to sᵣ^{(D-1)}.

The nonlinear transformer 234 performs nonlinear transformation processing using a predetermined activation function. Therefore, the MIMO equalizer 23ᵣ inputs the sum signal (xeᵣ+uᵣ₋₁) to the activation function used by the nonlinear transformer 234. The activation function is a nonlinear function in which the relationship between the input and output is nonlinear. The output of the activation function is then used as the auxiliary signal sᵣ.

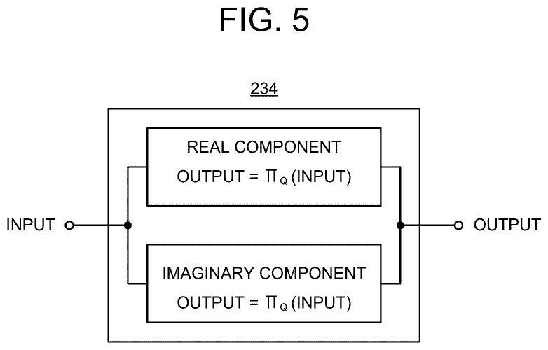

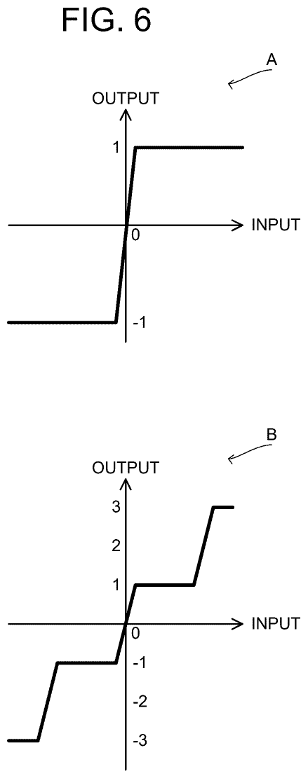

The nonlinear transformation processing performed by the nonlinear transformer 234 is represented by the formula shown in FIG. 6. The symbol “Π_{Q}” in Formula 6 denotes the output of the activation function. In this case, as shown in FIG. 5 illustrating the configuration of the nonlinear transformer 234, the nonlinear transformer 234 may perform nonlinear processing on the real component of the input and nonlinear processing on the imaginary component of the input separately. In other words, the nonlinear transformer 234 may perform the processing of inputting the real component of the sum signal (xeᵣ+uᵣ₋₁) into the activation function and obtaining its output, and the processing of inputting the imaginary component of the sum signal (xeᵣ+uᵣ₋₁) into the activation function and obtaining its output, separately.

$${s}_{r}^{( k )} ← {\prod }_{Q} ( {xe}_{r}^{( k )} + {u}_{r - 1}^{( k )} ) , k = 0 , 1 , … , D - 1 \qquad [ Formula 6 ]$$

An example of the relationship between the input and output in the activation function is shown in FIG. 6. The relationship between the input and output in the activation function may be determined depending on the modulation scheme of the transmitted signal x. In other words, the activation function may be determined depending on the modulation scheme of the transmitted signal x. As an example, graph A shows the transmitted signal x represented by four points (+1+√(−1), +1−√(−1), −1+√(−1), −1−√(−1) in the complex plane, the QPSK (Quadrature Phase Shift Keying) modulation scheme. Graph B shows an example of the relationship between input and output in the activation function in a case where the modulation scheme of the transmitted signal x is represented by the points (+3+3√(−1), +3−3√(−1), −3+3√(−1), −3−3√(−1), +3+√(−1), +3−√(−1), −3+√(−1), −3−√(−1), +1+3√(−1), +1−3√(−1), −1+3√(−1), −1−3√(−1), +1+√(−1), +1−√(−1), −1+√(−1), −1−√(−1)) represents the transmitted signal x in a 16-QAM (Quadrature Amplitude Modulation) system.

Referring again to FIG. 4, the MIMO equalizer 23ᵣ generates the auxiliary signal uᵣ using the nonlinear transformer 234 (step S24). Specifically, the MIMO equalizer 23ᵣ uses the adder 231e to generate the auxiliary signal uᵣ as the difference between the sum signal (xᵣ+uᵣ₋₁) input to the nonlinear transformer 234 and the auxiliary signal sᵣ output from the nonlinear transformer 234. Specifically, the MIMO equalizer 23ᵣ uses the adder 231e to calculate the difference between the sum signal (xeᵣ^{(k)}+uᵣ₋₁^{(k)}) and the auxiliary signal sᵣ^{(k)} as the auxiliary signal uᵣ^{(k)}. This process is repeated while varying the variable k from 0 to D-1, thereby generating plurality of auxiliary signals uᵣ⁽⁰⁾ to uᵣ^{(D-1)}. In other words, the MIMO equalizer 23ᵣ generates plurality of auxiliary signals uᵣ⁽⁰⁾ to uᵣ^{(D-1)} by performing the operation shown in formula 7.

$${u}_{r}^{( k )} ← {u}_{r - 1}^{( k )} + {xe}_{r}^{( k )} - {s}_{r}^{( k )} , k = 0 , 1 , … , D - 1 \qquad [ Formula 7 ]$$

Then, the signal processing apparatus 21 determines whether the variable r is less than the constant R (step S25). In a case it is determined that the variable r is less than the constant R (step S25: Yes), the signal processing apparatus 21 increments the variable r by 1 (step S26) and repeats the processing from step S23 to step S25. On the other hand, in a case it is determined that the variable r is not less than the constant R (step S25: No), it is assumed that the Rth MIMO equalizer 23_{R} generates plurality of estimated signals xe_{R}⁽⁰⁾ to xe_{R}^{(D-1)}. Therefore, in this case, the signal processing apparatus 21 outputs the plurality of estimated signals xe_{R}⁽⁰⁾ to xe_{R}^{(D-1)} generated by the Rth MIMO equalizer 23_{R} as the final estimated results of the plurality of transmitted signals x⁽⁰⁾ to x^{(D-1)} (step S27).

### <2-3> Technical Effects of MIMO Equalization Processing

As described above, the receiving apparatus 2 uses the plurality of MIMO equalizers 23 equipped with two linear equalizers 232 and 233 and one nonlinear transformer 234 to estimate plurality of transmitted signals x⁽⁰⁾ to x^{(D-1)}. In other words, the receiving apparatus 2 uses the plurality of MIMO equalizers 23, each including two linear equalizers 232 and 233 and one nonlinear transformer 234, to generate the plurality of estimated signals xe⁽⁰⁾ to x^{(D-1)}. Therefore, the receiving apparatus 2 can improve the estimation accuracy of the plurality of transmitted signals x⁽⁰⁾ to x^{(D-1)} (i.e., the estimation accuracy of the plurality of estimated signals xe⁽⁰⁾ to xe^{(D-1)}). In other words, the receiving apparatus 2 can generate the plurality of estimated signals xe⁽⁰⁾ to xe^{(D-1)} with fewer errors.

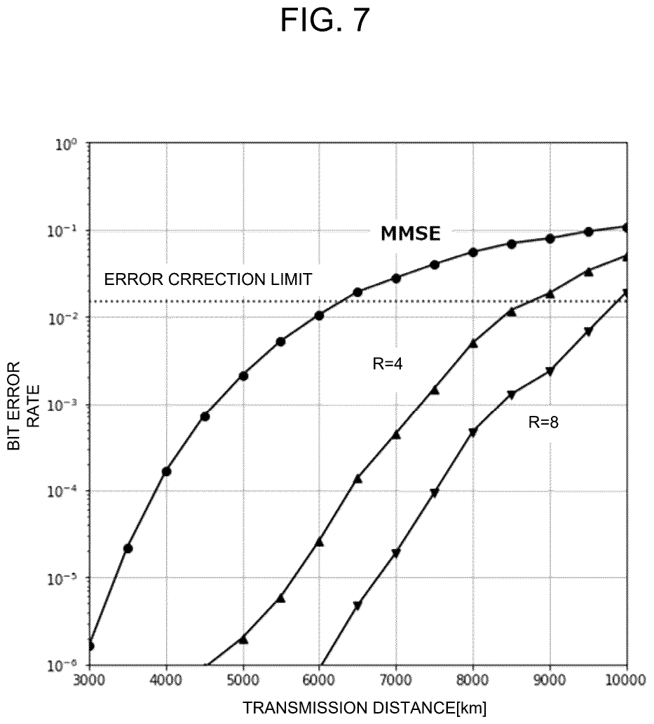

For example, FIG. 7 is a graph showing the bit error rate of plurality of estimated signals xe⁽⁰⁾ to xe^{(D-1)} estimated by the receiving apparatus 2 of this example embodiment and the bit error rate of the plurality of estimated signals xe⁽⁰⁾ to xe^{(D-1)} estimated by MMSE estimation processing as a comparison example on the horizontal axis, and the transmission distance on the vertical axis. In the example shown in FIG. 7, the bit error rates of the plurality of estimated signals xe⁽⁰⁾ to xe^{(D-1)} estimated by the receiving apparatus 2 of the present example embodiment are shown for cases where the number R of MIMO equalizers 23 is 4 and where the number R of MIMO equalizers 23 is 8. Note that the bit error rates shown in FIG. 7 are calculated under the following conditions: a wired transmission line including a coupled multi-core optical fiber with four cores is used as the transmission line 3; the multiplexing number D is eight by combining four cores with polarization multiplexing; the mode dependent loss (MDL) related to interference (i.e., crosstalk) between multiple cores is 0.1 db/√(km); and the modal group delay (MGD) is 20 ps/√(km).

As shown in FIG. 7, in the MMSE estimation processing used as a comparison example, the bit error rate exceeds the upper limit value at which error correction becomes impossible in a case the transmission distance is approximately 6,200 km. On the other hand, according to the receiving apparatus 2 of the present example embodiment, even in a case the transmission distance exceeds approximately 6,200 km, the bit error rate does not exceed the upper limit value at which error correction becomes impossible. In the example shown in FIG. 7, according to the receiving apparatus 2, the bit error rate in a case the number R of MIMO equalizers 23 is 4 does not exceed the upper limit value at which error correction becomes impossible until the transmission distance exceeds approximately 8,700 km. Similarly, in the example shown in FIG. 7, according to the receiving apparatus 2, the bit error rate in a case the number R of MIMO equalizers 23 is 8 does not exceed the upper limit value at which error correction becomes impossible until the transmission distance exceeds approximately 9,800 km. In this way, in the present example embodiment, the receiving apparatus 2 can generate the plurality of estimated signals xe⁽⁰⁾ to xe^{(D-1)} with fewer errors, thereby enabling the realization of extended transmission distances.

### <3> Coefficient Update Operation Performed by Coefficient Update Apparatus 4

Next, the coefficient update operation performed by coefficient update apparatus 4 will be described.

### <3-1> Configuration of Coefficient Update Apparatus 4 (Signal Processing Apparatus 41)

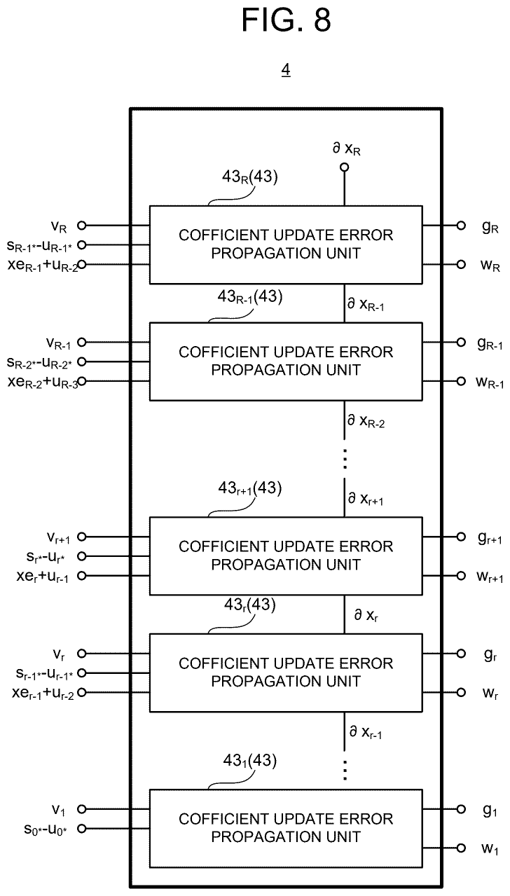

First, with reference to FIG. 8, the configuration of coefficient update apparatus 4 that performs the coefficient update operation (in particular, the configuration of signal processing apparatus 41) will be described. FIG. 8 is a block diagram showing the logical functional blocks realized within signal processing apparatus 41 for performing coefficient update operations.

As shown in FIG. 8, signal processing apparatus 41 includes a plurality of coefficient update error propagation units 43 as logical functional blocks for performing coefficient update operations. Note that FIG. 8 merely shows the logical functional blocks for performing coefficient update operations in a conceptual (i.e., simplified) manner. In other words, the functional blocks shown in FIG. 8 do not necessarily need to be implemented as they are in the signal processing apparatus 41. As long as the signal processing apparatus 41 can perform the coefficient update operations performed by the functional blocks shown in FIG. 8, the configuration of the functional blocks implemented in the signal processing apparatus 41 is not limited to the configuration shown in FIG. 8.

The number of coefficient update error propagation units 43 provided in the signal processing apparatus 41 is the same as the number of MIMO equalizers 23 provided in the signal processing apparatus 21 of the receiving apparatus 2. Therefore, the following description will explain an example in which the signal processing apparatus 41 is provided with R coefficient update error propagation units 43. Specifically, the following description explains an example in which the signal processing apparatus 41 includes coefficient update error propagation unit 43₁, coefficient update error propagation units 43₂, . . . , coefficient update error propagation units 43ᵣ₋₁, coefficient update error propagation unit 43ᵣ, . . . , coefficient update error propagation unit 43_{R-1}, and coefficient update error propagation unit 43_{R} as R coefficient update error propagation units 43.

The coefficient update error propagation unit 43ᵣ updates (sets) filter coefficients gᵣ and wᵣ. The coefficient update error propagation unit 43ᵣ updates (sets) the filter coefficients gᵣ and wᵣ by obtaining, from the receiving apparatus 2, the difference signal vᵣ corresponding to the difference between the convolution signal dᵣ and a plurality of received signals y, and the difference signal (sᵣ₋₁*−uᵣ₋₁*) corresponding to the difference between the complex conjugate of the auxiliary signal sᵣ₋₁ and the complex conjugate of the auxiliary signal uᵣ₋₁, and an addition signal (xᵣ₋₁+uᵣ₋₂) corresponding to the sum of the estimated signal xᵣ₋₁ and the auxiliary signal uᵣ₋₂ from the receiving apparatus 2. In the following description, the complex conjugate of signal A is denoted by the symbol A*. The coefficient update error propagation unit 43ᵣ updates (sets) the filter coefficients gᵣ and wᵣ using the difference signal vᵣ, the difference signal (sᵣ₋₁*−uᵣ₋₁*), and the sum signal (xeᵣ₋₁+uᵣ₋₂).

Furthermore, the coefficient update error propagation unit 43ᵣ obtains the error signal ∂xᵣ to update (set) the filter coefficients gᵣ and wᵣ. The error signal ∂xᵣ indicates the difference (error) between the estimated results of the plurality of transmitted signals x by the receiving apparatus 2 and the plurality of transmitted signals x actually transmitted by the transmitting apparatus 1. In other words, the error signal ∂xᵣ indicates the difference (error) between the plurality of estimated signals xe generated by the receiving apparatus 2 and the plurality of transmitted signals x actually transmitted by the transmitting apparatus 1.

In this example embodiment, the error signal ∂xᵣ is generated by the coefficient update error propagation unit 43ᵣ₊₁ using the difference signal vᵣ₊₁, the difference signal (sᵣ*−uᵣ*), the addition signal (x_{r*}+uᵣ₋₁), and the error signal ∂xᵣ₊₁. Therefore, the coefficient update error propagation unit 43ᵣ obtains the error signal ∂xᵣ from the coefficient update error propagation unit 43ᵣ₊₁. Therefore, the plurality of coefficient update error propagation units 43 are connected in series (in other words, coupled in series) so that the error signal ∂xᵣ output from coefficient update error propagation unit 43ᵣ₊₁ is input to coefficient update error propagation unit 43ᵣ.

However, there is no coefficient update error propagation unit 43_{R+1} that generates the error signal ∂x_{R} to be acquired by coefficient update error propagation unit 43_{R}. Therefore, the difference (error) between the plurality of estimated signals xe actually generated by the receiving apparatus 2 and the plurality of transmitted signals x actually transmitted by the transmitting apparatus 1 may be used as the error signal ∂x_{R}.

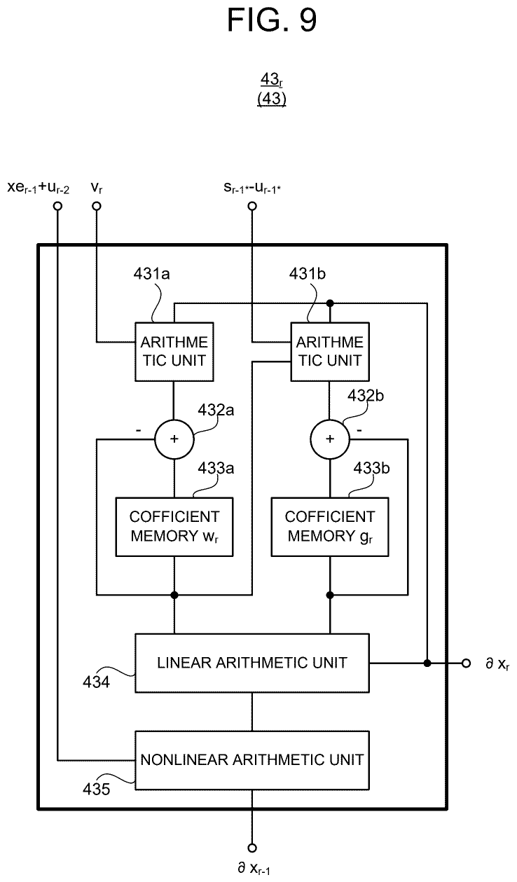

An example of the configuration of the coefficient update error propagation unit 43ᵣ is shown in FIG. 9. As shown in FIG. 9, the coefficient update error propagation unit 43ᵣ includes an arithmetic unit 431a, an arithmetic unit 431b, an adder 432a, an adder 432b, a coefficient memory 433a, a coefficient memory 433b, a linear arithmetic unit 434, and a nonlinear arithmetic unit 435.

### <3-2> Flow of Coefficient Update Operation

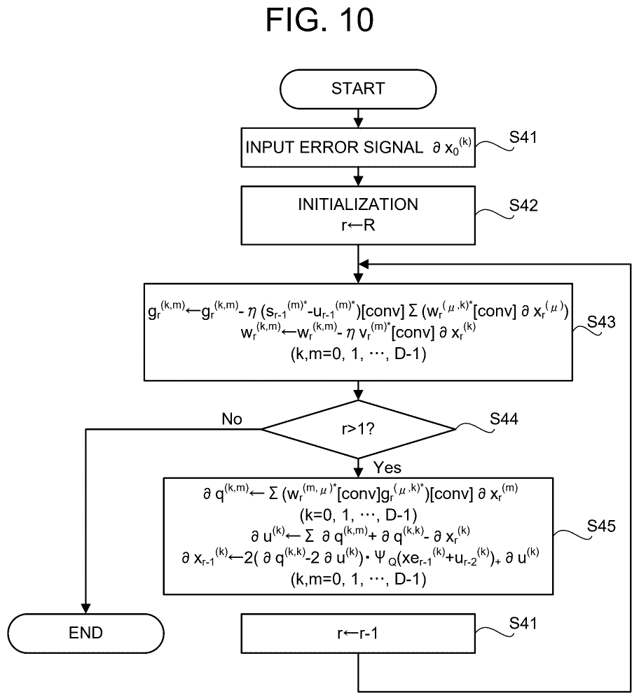

Next, with reference to FIG. 8 and FIG. 9 and FIG. 10, the coefficient update operation performed by the coefficient update apparatus 4 using the plurality of coefficient update error propagation units 43 will be described. FIG. 10 is a flowchart showing the flow of the coefficient update operation.

As shown in FIG. 10, an error signal ∂x_{R} is input to the signal processing apparatus 41 of the coefficient update apparatus 4 (step S41). The error signal ∂x_{R} includes D error signals ∂x_{R}⁽⁰⁾ to ∂x_{R}^{(D-1)}. The error signal ∂x_{R}^{(k)} is the difference between the estimated signal xe^{(k)} actually generated by the receiving apparatus 2 and the transmitted signal x^{(k)} actually transmitted by the transmitting apparatus 1.

As mentioned above, the error signal ∂x_{R} is the difference (error) between the plurality of estimated signals xe actually generated by the receiving apparatus 2 and the plurality of transmitted signals x actually transmitted by the transmitting apparatus 1. Therefore, in step S41, the plurality of estimated signals xe actually generated by the receiving apparatus 2 and the plurality of transmitted signals x actually transmitted by the transmitting apparatus 1 may be input to the signal processing apparatus 41 of the coefficient update apparatus 4. In this case, the signal processing apparatus 41 may generate the error signal ∂x_{R} based on the plurality of estimated signals xe and the plurality of transmitted signals x input to the signal processing apparatus 41.

Furthermore, the signal processing apparatus 41 performs an initialization process (step S42). Specifically, the signal processing apparatus 21 initializes the variable r to the constant R.

Thereafter, the coefficient update error propagation unit 43ᵣ updates the filter coefficient wᵣ (step S43). Specifically, the coefficient update error propagation unit 43, repeats the process of updating the filter coefficient wᵣ^{(k, m)} while changing the variables k and m from 0 to D-1, thereby updating the filter coefficient wᵣ^{(0, 0)} to the filter coefficient wᵣ^{(D-1,D-1)}.

To update the filter coefficient wᵣ^{(k, m)}, the coefficient update error propagation unit 43r performs a convolution operation between the complex conjugate of the difference signal vᵣ^{(m)} and the error signal ∂xᵣ^{(k)} using the arithmetic unit 431a. Furthermore, the coefficient update error propagation unit 43ᵣ uses the arithmetic unit 431a to multiply the result of the convolution operation (i.e., vᵣ^{(m)*}[conv]∂xᵣ^{(k)}) by the learning rate η, which is a predetermined real value. Then, the coefficient update error propagation unit 43ᵣ uses the adder 432a to subtract the output of the arithmetic unit 431a (i.e., η×vᵣ^{(m)*}[conv]∂xᵣ^{(k)}) from the current filter coefficient wᵣ^{(k, m)} stored in the coefficient memory 433a, thereby updating the filter coefficient wᵣ^{(k, m)}. In other words, the coefficient update error propagation unit 43ᵣ updates the filter coefficient wᵣ^{(k,m)} by performing the operation (including linear operations) shown in formula 8 using the arithmetic unit 431a and the adder 432a.

$${w}_{r}^{( k , m )} ← {w}_{r}^{( k , m )} - η \times {v}_{r}^{( m ) *} [ conv ] \partial {x}_{r}^{( k )} , k , m = 0 , 1 , … , D - 1 \qquad [ Formula 8 ]$$

The updated filter coefficient wᵣ^{(k, m)} is stored in the coefficient memory 433a. The linear equalizer 233 provided in the MIMO equalizer 23ᵣ described above performs filter processing using the filter coefficient wᵣ^{(k, m)} stored in the coefficient memory 433a. Therefore, the linear equalizer 233 provided in the MIMO equalizer 23ᵣ obtains the filter coefficient wᵣ^{(k, m)} stored in coefficient memory 433a and performs filter processing using the acquired filter coefficient wᵣ^{(k, m)}. Note that if the filter coefficient wᵣ^{(k, m)} has never been updated, coefficient memory 433a may store coefficients indicating zero as the initial values of the filter coefficient wᵣ^{(k, m)}. Alternatively, coefficient memory 433a may store coefficients that satisfy the condition that the average value of filter coefficient wᵣ^{(k, m)} is zero as the initial values of filter coefficients wᵣ^{(k, m)}.

Furthermore, coefficient update error propagation unit 43ᵣ updates filter coefficient gᵣ(step S43). Specifically, the coefficient update error propagation unit 43, repeats the process of updating the filter coefficient gᵣ^{(k, m)} while changing the variables k and m from 0 to D-1, thereby updating the filter coefficient gᵣ^{(0, 0)} to the filter coefficient gᵣ^{(D-1,D-1)}.

To update the filter coefficients gᵣ^{(k,m)}, the coefficient update error propagation unit 43ᵣ uses the calculator 431b to perform a first convolution operation to calculate a convolution signal between the complex conjugate of the filter coefficient wᵣ^{(μ,k)} before update and the error signal ∂xᵣ^{(μ)}, while repeatedly changing the variable p, which indicates a variable from 0 to D-1, from 0 to D-1. The coefficient update error propagation unit 43ᵣ then uses the calculator 431b to calculate a sum of the results of the first convolution operation. The coefficient update error propagation unit 43ᵣ then uses the calculator 431b to perform a second convolution operation to calculate a convolution signal between the sum of the results of the first convolution operation and a difference signal (sᵣ₋₁^{(m)}*−uᵣ₋₁^{(m)}*) corresponding to the difference between the complex conjugate of the auxiliary signal sᵣ₋₁^{(m)} and the complex conjugate of the auxiliary signal uᵣ₋₁^{(m)}. Then, the coefficient update error propagation unit 43ᵣ uses the calculator 431b to multiply the result of the second convolution operation by a learning rate η, which is a preset real value. Then, the coefficient update error propagation unit 43ᵣ uses the adder 432b to subtract the output of the calculator 431b from the current filter coefficient gᵣ^{(k, m)} stored in the coefficient memory 433a, thereby updating the filter coefficient gᵣ^{(k, m)}. That is, the coefficient update error propagation unit 43ᵣ updates the filter coefficient gᵣ^{(k, m)} by performing the operation shown in Equation 9 (including linear operation) using the calculator 431b and the adder 432b.

$${g}_{r}^{( k , m )} ← {g}_{r}^{( k , m )} - η \times ( {s}_{r - 1}^{( m ) *} - {u}_{r - 1}^{( m ) *} ) [ conv ] {\sum }_{μ = 0}^{D - 1} ( {w}_{r}^{( μ , k ) *} [ conv ] \partial {x}_{r}^{( μ )} ) , \qquad [ Formula 9 ]$$

The updated filter coefficient gᵣ^{(k, m)} is stored in coefficient memory 433b. The linear equalizer 232 provided by the MIMO equalizer 23ᵣ described above performs filter processing using the filter coefficient gᵣ^{(k, m)} stored in coefficient memory 433b. Therefore, the linear equalizer 232 provided in the MIMO equalizer 23ᵣ acquires the filter coefficients gᵣ^{(k, m)} stored in the coefficient memory 433a and performs filter processing using the acquired filter coefficients gᵣ^{(k, m)}. Note that in a case the filter coefficients gᵣ^{(k, m)} have never been updated, the coefficient memory 433b may store coefficients indicating zero as the initial values of the filter coefficients gᵣ^{(k, m)}. Alternatively, coefficient storage apparatus 433b may store coefficients that satisfy the condition that the average value of filter coefficients gᵣ^{(k, m)} is zero as the initial values of filter coefficients gᵣ^{(k, m)}.

Then, signal processing apparatus 41 determines whether variable r is greater than 1 (step S44).

In a case the determination in step S44 is Yes, it is assumed that at least the filter coefficients gᵣ₋₁ and wᵣ₋₁ have not been updated. Therefore, in this case, the coefficient update error propagation unit 43ᵣ generates an error signal ∂xᵣ₋₁ used to update the filter coefficients gᵣ₋₁ and wᵣ₋₁ (step S45). Specifically, the coefficient update error propagation unit 43ᵣ generates an error signal ∂xᵣ₋₁ containing D error signals ∂xᵣ₋₁⁽⁰⁾ to ∂xᵣ₋₁^{(D-1)}. In other words, the coefficient update error propagation unit 43ᵣ generates the error signal ∂xᵣ₋₁^{(k)} by repeating the process of generating the error signal ∂xᵣ₋₁^{(k)} while varying the variable k from 0 to D-1, thereby generating the error signal ∂xᵣ₋₁ containing D error signals ∂xᵣ₋₁⁽⁰⁾ to ∂xᵣ₋₁^{(D-1)}.

To generate the error signal ∂xᵣ₋₁^{(k)}, the coefficient update error propagation unit 43ᵣ uses the linear processor 434 to perform the operation (including linear operations) shown in formula 10 to generate the intermediate signal ∂q^{(k, m)} (step S45). Specifically, the coefficient update error propagation unit 43ᵣ repeats the third convolution operation to calculate the convolution signal between the complex conjugate of the pre-updated filter coefficient wᵣ^{(m, μ)} and the complex conjugate of the pre-updated filter coefficient gᵣ^{(μ, k)}, while varying the variable μ from 0 to D-1. Furthermore, the coefficient update error propagation unit 43ᵣ calculates the sum of the results of the third convolution operation. Thereafter, the coefficient update error propagation unit 43ᵣ performs a fourth convolution operation to calculate the convolution signal between the sum of the results of the third convolution operation and the error signal ∂xᵣ^{(m)}. As a result, an intermediate signal ∂q^{(k, m)} is generated as the result of the fourth convolution operation.

$$\partial {q}^{( k , m )} ← {\sum }_{μ = 0}^{D - 1} ( {w}_{r}^{( m , μ ) *} [ conv ] {g}_{r}^{( μ , k ) *} ) [ conv ] \partial {x}_{r}^{( m )} \qquad [ Formula 10 ]$$

Then, the coefficient update error propagation unit 43ᵣ generates an intermediate signal ∂u^{(k)} by performing the operation shown in Formula 11 using the linear operation unit 434 (step S45). Specifically, the coefficient update error propagation unit 43ᵣ calculates the sum of the intermediate signals ∂q^{(k, 0)} to the intermediate signals ∂q^{(k, D-1)}, adds the calculated sum to the intermediate signal ∂q^{(k, k)}, and subtracts the error signal ∂xᵣ^{(k)} from the sum to generate the intermediate signal ∂u^{(k)}.

$$\partial {u}^{( k )} ← {\sum }_{m = 0}^{D - 1} \partial {q}^{( k , m )} + \partial {q}^{( k , k )} - \partial {x}_{r}^{( k )} \qquad [ Formula 11 ]$$

Furthermore, the coefficient update error propagation unit 43ᵣ generates an intermediate signal ∂p^{(k)} by performing the operation shown in Formula 12 using the linear operation unit 434 (step S45). Specifically, the coefficient update error propagation unit 43ᵣ subtracts twice the intermediate signal ∂u^{(k)} from the intermediate signal ∂q^{(k, k)}, and then doubles the result of the subtraction to generate the intermediate signal ∂p^{(k)}.

$$\partial {p}^{( k )} ← 2 \times ( \partial {q}^{( k , k )} - 2 \times \partial {u}^{( k )} ) \qquad [ Formula 12 ]$$

Thereafter, the coefficient update error propagation unit 43ᵣ generates the error signal ∂xᵣ₋₁^{(k)} by performing the calculation (nonlinear calculation) shown in Equation 13 using the nonlinear calculator 435 (step S45). Specifically, the coefficient update error propagation unit 43ᵣ inputs the sum signal (xeᵣ₋₁^{(k)}+uᵣ₋₂^{(k)}) corresponding to the sum of the estimated signal xeᵣ₋₁^{(k)} and the auxiliary signal uᵣ₋₂^{(k)} to the derivative Ψ_{Q} (i.e., dΠ_{Q}(x)/dx) of the activation function (Π_{Q}(x)). Therefore, it can be said that the coefficient update error propagation unit 43ᵣ performs nonlinear processing on the sum signal (xeᵣ₋₁^{(k)}+uᵣ₋₂^{(k)}) corresponding to the differentiation process of the nonlinear transformation process using the activation function. Then, the coefficient update error propagation unit 43ᵣ multiplies the real part of the output of the derivative Ψ_{Q} by the real part of the intermediate signal ∂p^{(k)}, and multiplies the imaginary part of the output of the derivative Ψ by the imaginary part of the intermediate signal ∂p^{(k)}, and adds the multiplication results. Note that the symbol “@” in Equation 13 is an operator indicating an operation of adding the multiplication result of the real part of a complex number by the multiplication result of the imaginary part of a complex number. Therefore, (a+ib) @(c+id) represents ac+ibd (note that a, b, c, and d each represent a real number, and i represents the imaginary unit). Then, the coefficient update error propagation unit 43ᵣ generates ∂xᵣ₋₁^{(k)} by adding the intermediate signal ∂u^{(k)} to the sum of the multiplication results.

$$\partial {x}_{r - 1}^{( k )} ← \partial {p}^{( k )} @ {Ψ}_{Q} ( {xe}_{r - 1}^{( k )} + {u}_{r - 1}^{( k )} ) + \partial {u}^{( k )} \qquad [ Formula 13 ]$$

On the other hand, in a case it is determined that the variable r is not greater than 1 (step S44: No), it is assumed that all filter coefficients g₁ to g_{R} and filter coefficients w₁ to w_{R} have been updated. In this case, the signal processing apparatus 41 terminates the coefficient update operation.

### <3-3> Modified Example of the Coefficient Update Operation

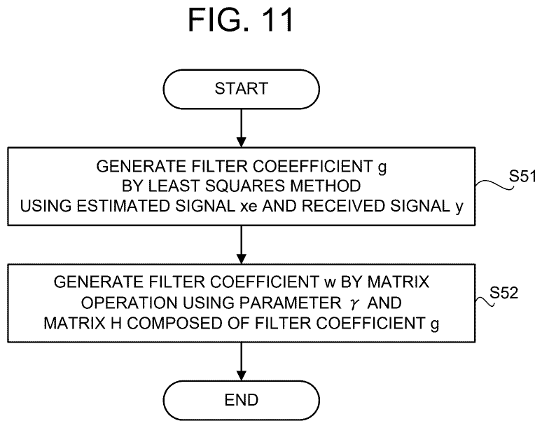

The coefficient update apparatus 4 may generate filter coefficients g and w that are commonly used by the plurality of MIMO equalizers 23 by performing the modified example of the coefficient update operation shown in FIG. 11. In other words, in this case, the filter coefficients g are a vector of filter coefficients including g^{(0, 0)} to g^{(D-1, D-1)} which are filter coefficients commonly used by the linear equalizers 232 provided by each of the MIMO equalizers 231 to 23R. Similarly, the filter coefficients w are a vector of filter coefficients including filter coefficients w^{(0, 0)} to w^{(D-1, D-1)} that are commonly used by the linear equalizers 233 provided in each of the MIMO equalizers 231 to 23R.

To generate filter coefficients g^{(0, 0)} to g^{(D-1, D-1)} the signal processing apparatus 41 generates filter coefficients g^{(0, 0)} to g^{(D-1, D-1)} using the least squares method from plurality of estimated signals xe, which are the estimated results of the plurality of transmitted signals x, and the plurality of received signals y (step S51). Specifically, the signal processing apparatus 41 generates filter coefficients g^{(0, 0)} to g^{(D-1, D-1)} that satisfy the condition of minimizing the parameter a shown in formula 14. Note that the operation of generating filter coefficients g^{(0, 0)} to g^{(D-1, D-1)} that satisfy the condition of minimizing the parameter δ shown in formula 14 may be considered equivalent to the operation of generating filter coefficients g^{(0, 0)} to g^{(D-1, D-1)} from the impulse response of transmission line 3.

$$δ = {\sum }_{k = 0}^{D - 1} {‖ {y}^{( k )} - {\sum }_{m = 0}^{D - 1} {g}^{( k , m )} [ conv ] {x}^{( m )} ‖}^{2} \qquad [ Formula 14 ]$$

Furthermore, to generate filter coefficients w^{(0, 0)} to w^{(D-1, D-1)}, the signal processing apparatus 41 generates filter coefficients w^{(0, 0)} to w^{(D-1, D-1)} by matrix operations using a matrix H composed of filter coefficients g and an arbitrarily settable parameter γ (step S52). Specifically, the signal processing apparatus 41 generates a matrix H whose components are filter coefficients g. Then, the signal processing apparatus 41 performs the matrix operation shown in formula 15 using the matrix H and the parameter γ to calculate the matrix W. The symbol “+” in formula 15 indicates the Hermitian transpose matrix (i.e., the conjugate transpose matrix). The symbol “I” in Formula 15 denotes an N×N identity matrix. Subsequently, the signal processing apparatus 41 classifies the components of the matrix W into D×D groups w^{(k, m)}. Then, the signal processing apparatus 41 outputs the D×D groups w^{(k, m)} as filter coefficients w^{(0, 0)} to w^{(D-1, D-1)}.

$$W = {{H}^{+} ( {HH}^{+} + γ I )}^{- 1} \qquad [ Formula 15 ]$$

Furthermore, in a case the coefficient update apparatus 4 performs a modified coefficient update operation to generate filter coefficients g and w, the coefficient update apparatus 4 may not necessarily include the plurality of coefficient update error propagation units 43.

### <4> Supplementary Note

With regard to the above-described example embodiment, the following Supplementary Note is disclosed.

### [Supplementary Note 1]

A signal estimation apparatus that estimates a plurality of transmitted signals respectively corresponding to a plurality of received signals that are spatially multiplexed, from the plurality of received signals,
the signal estimation apparatus including a plurality of signal estimation units,
each of the plurality of signal estimation units includes two linear equalizers and one nonlinear transformer that performs nonlinear transformation,
the plurality of signal estimation units being connected in series such that output signals generated by a r-1th signal estimation unit (here, r is a variable indicating an integer greater than or equal to 2 and less than or equal to the number of the plurality of signal estimation units) using the two linear equalizers and the nonlinear transformer provided in the r-1th signal estimation unit is input to a rth signal estimation unit connected subsequent to the r-1th signal estimation unit, and
the rth signal estimation unit generates output signals using the two linear equalizers and the nonlinear transformer provided in the rth signal estimation unit, from the plurality of received signals and the output signals generated by the r-1th signal estimation unit using the two linear equalizers and the nonlinear transformer provided in the r-1th signal estimation unit.

### [Supplementary Note 2]

The signal estimation apparatus according to Supplementary Note 1, wherein
each of the plurality of signal estimation units uses the two linear equalizers and the nonlinear transformer to generate, as the output signals, a plurality of estimated signals which are provisional estimation results of the plurality of transmitted signals, and auxiliary signals;
the rth signal estimation unit uses the two linear equalizers and the nonlinear transformer provided in the rth signal estimation unit to generate, as the output signals, the plurality of estimated signals and the auxiliary signals from the auxiliary signals generated by the r-1th signal estimation unit and the plurality of received signals; and
the plurality of estimated signals generated by a Rth signal estimation unit (R is a constant indicating the number of signal estimation units) among the plurality of signal estimation units are used as the plurality of transmitted signals respectively corresponding to the plurality of received signals.

### [Supplementary Note 3]

The signal estimation apparatus according to Supplementary Note 2, wherein
each of the plurality of signal estimation units generates a first auxiliary signal and a second auxiliary signal as the auxiliary signals,
a first linear equalizer of the two linear equalizers provided in the rth signal estimation unit performs a first filter process using the first and second auxiliary signals generated by the r-1th signal estimation unit,
a second linear equalizer of the two linear equalizers provided in the rth signal estimation unit performs a second filter process using an output of the first linear equalizer provided in the rth signal estimation unit and the plurality of received signals,
the rth signal estimation unit generates the plurality of estimated signals by adding a difference between the first and second auxiliary signals generated by the r-1th signal estimation unit to an output of the second linear equalizer provided in the rth signal estimation unit,
the nonlinear transformer provided in the rth signal estimation unit generates an output of a predetermined activation function as the first auxiliary signal by inputting an additive signal generated by adding the plurality of estimated signals generated by the rth signal estimation unit and the second auxiliary signal generated by the r-1th signal estimation unit to the activation function, and
the rth signal estimation unit generates a first differential signal, which is a difference between the output of the activation function and the input of the activation function, as the second auxiliary signal.

### [Supplementary Note 4]

The signal estimation apparatus according to Supplementary Note 3, wherein
the first linear equalizer provided in the rth signal estimation unit performs a convolution operation as the first filter processing using a first filter coefficient and a second differential signal which is a difference between the first and second auxiliary signals generated by the r-1th signal estimation unit, and
the second linear equalizer provided in the rth signal estimation unit performs a convolution operation as the second filter processing using a second filter coefficient and a third differential signal which is a difference between the output of the first linear equalizer provided in the rth signal estimation unit and the plurality of received signals.

### [Supplementary Note 5]

The signal estimation apparatus according to any one of Supplementary Notes 1 to 4, wherein
a first linear equalizer of the two linear equalizers provided in the rth signal estimation unit performs a first filter processing using a first filter coefficient updated by a coefficient updating apparatus, and
a second linear equalizer of the two linear equalizers provided in the rth signal estimation unit performs a second filter processing using a second filter coefficient updated by the coefficient updating apparatus.

### [Supplementary Note 6]

The signal estimation apparatus according to Supplementary Note 5, wherein
the coefficient updating apparatus includes a plurality of coefficient update error propagation units, the number of which is the same as the number of the plurality of signal estimation units, and
each of the plurality of coefficient update error propagation units updates an error signal which is a difference between estimation results of the plurality of transmitted signals by the signal estimation apparatus and correct values of the plurality of transmitted signals, and
a rth coefficient update error propagation unit among the plurality of coefficient update error propagation units, which updates first and second filter coefficients used by the rth signal estimation unit, updates the first and second filter coefficients by performing a linear operation of subtracting a result of a convolution operation using the output signals and an error signal updated by a r+1th coefficient update error propagation unit among the plurality of coefficient update error propagation units, which updates first and second filter coefficients used by a r+1th signal estimation unit, from the first and second filter coefficients before updating, and
the rth coefficient update error propagation unit updates the error signal by performing a convolution operation using the first and second filter coefficients, and performing a nonlinear transformation equivalent to a differentiation process of a nonlinear transformation performed by the nonlinear transformer by using the result of the convolution operation.

### [Supplementary Note 7]

The signal estimation apparatus according to Supplementary Note 5, wherein
the coefficient updating apparatus updates the first filter coefficient from estimation results of the plurality of transmitted signals by the signal estimation apparatus and the plurality of received signals, using a method of estimating an impulse response of a transmission path by a least squares method, and
the coefficient updating apparatus generates a second matrix from a first matrix having element of the first filter coefficient and a predetermined numerical parameter, acquired by adding the numerical parameters to diagonal element of a product matrix of the first matrix and a conjugate arrangement matrix of the first matrix, and updates the second filter coefficient by calculating element of a product matrix of the first matrix and an inverse matrix of the second matrix as the second filter coefficient.

### [Supplementary Note 8]

A signal estimation method for estimating a plurality of transmitted signals respectively corresponding to a plurality of received signals that are spatially multiplexed, from the plurality of received signals, the signal estimation method including:
inputting the plurality of received signals; and
estimating the plurality of transmitted signals from the plurality of received signals using a plurality of signal estimation units connected in series,
each of the plurality of signal estimation units including two linear equalizers and one nonlinear transformer that performs nonlinear transformation, and
the estimating the plurality of transmitted signals includes:
   inputting output signals generated by a i-1th signal estimation unit (here, i is a variable indicating an integer equal to or greater than 2 and less than the number of signal estimation units) using the two linear equalizers and the nonlinear transformer provided in the i-1th signal estimation unit to a ith signal estimation unit connected subsequent to the i-1th signal estimation unit; and
   generating output signals to be output by the ith signal estimation unit by using the two linear equalizers and the nonlinear transformer provided in the ith signal estimation unit, from the plurality of received signals and the output signals generated by the i-1-th signal estimation unit using the two linear equalizers and the nonlinear transformer provided in the i-1-th signal estimation unit.

### [Supplementary Note 9]

A recording medium on which a computer program is stored, the computer program being configured to allow a computer to execute a signal estimation method for estimating a plurality of transmitted signals respectively corresponding to a plurality of received signals that are spatially multiplexed, from the plurality of received signals, the signal estimation method including:
inputting the plurality of received signals; and
estimating the plurality of transmitted signals from the plurality of received signals using a plurality of signal estimation units connected in series,
each of the plurality of signal estimation units including two linear equalizers and one nonlinear transformer that performs nonlinear transformation, and
the estimating the plurality of transmitted signals includes:
   inputting output signals generated by a i-1th signal estimation unit (here, i is a variable indicating an integer equal to or greater than 2 and less than the number of signal estimation units) using the two linear equalizers and the nonlinear transformer provided in the i-1th signal estimation unit to a ith signal estimation unit connected subsequent to the i-1th signal estimation unit; and
   generating output signals to be output by the ith signal estimation unit by using the two linear equalizers and the nonlinear transformer provided in the ith signal estimation unit, from the plurality of received signals and the output signals generated by the i-1-th signal estimation unit using the two linear equalizers and the nonlinear transformer provided in the i-1-th signal estimation unit.

The present invention may be appropriately modified within the scope that does not contradict the essence or idea of the invention as read from the claims and the entire specification, and such modified communication systems, transmitting apparatuses, receiving apparatuses, transmitting methods, reception methods, and computer programs are also included in the technical concept of the present invention.

### DESCRIPTION OF REFERENCE CODES

1 transmitting apparatus
11 signal processing apparatus
122 signal synthesis unit
123 phase shift unit
125 feedback signal receiving unit
126 phase update unit
2 receiving apparatus
21 signal processing apparatus
222 MIMO equalization processing unit
224 communication status detection unit
225 phase control information generation unit
226 feedback signal generation unit
SYS wireless communication system

What is claimed is:

1. A signal estimation apparatus that estimates a plurality of transmitted signals respectively corresponding to a plurality of received signals that are spatially multiplexed, from the plurality of received signals,
the signal estimation apparatus comprising a plurality of signal estimation units,
each of the plurality of signal estimation units comprises two linear equalizers and one nonlinear converter that performs nonlinear conversion,
the plurality of signal estimation units being connected in series such that output signals generated by a r-1th signal estimation unit (here, r is a variable indicating an integer greater than or equal to 2 and less than or equal to the number of the plurality of signal estimation units) using the two linear equalizers and the nonlinear converter provided in the r-1th signal estimation unit is input to a rth signal estimation unit connected subsequent to the r-1th signal estimation unit, and
the rth signal estimation unit generates output signals using the two linear equalizers and the nonlinear converter provided in the rth signal estimation unit, from the plurality of received signals and the output signals generated by the r-1th signal estimation unit using the two linear equalizers and the nonlinear converter provided in the r-1th signal estimation unit.

2. The signal estimation apparatus according to claim 1, wherein
each of the plurality of signal estimation units uses the two linear equalizers and the nonlinear converter to generate, as the output signals, a plurality of estimated signals which are provisional estimation results of the plurality of transmitted signals, and auxiliary signals;
the rth signal estimation unit uses the two linear equalizers and the nonlinear converter provided in the rth signal estimation unit to generate, as the output signals, the plurality of estimated signals and the auxiliary signals from the auxiliary signals generated by the r-1th signal estimation unit and the plurality of received signals; and
the plurality of estimated signals generated by a Rth signal estimation unit (R is a constant indicating the number of signal estimation units) among the plurality of signal estimation units are used as the plurality of transmitted signals respectively corresponding to the plurality of received signals.

3. The signal estimation apparatus according to claim 2, wherein
each of the plurality of signal estimation units generates a first auxiliary signal and a second auxiliary signal as the auxiliary signals,
a first linear equalizer of the two linear equalizers provided in the rth signal estimation unit performs a first filter process using the first and second auxiliary signals generated by the r-1th signal estimation unit,
a second linear equalizer of the two linear equalizers provided in the rth signal estimation unit performs a second filter process using an output of the first linear equalizer provided in the rth signal estimation unit and the plurality of received signals,
the rth signal estimation unit generates the plurality of estimated signals by adding a difference between the first and second auxiliary signals generated by the r-1th signal estimation unit to an output of the second linear equalizer provided in the rth signal estimation unit,
the nonlinear converter provided in the rth signal estimation unit generates an output of a predetermined activation function as the first auxiliary signal by inputting an additive signal generated by adding the plurality of estimated signals generated by the rth signal estimation unit and the second auxiliary signal generated by the r-1th signal estimation unit to the activation function, and
the rth signal estimation unit generates a first differential signal, which is a difference between the output of the activation function and the input of the activation function, as the second auxiliary signal.

4. The signal estimation apparatus according to claim 3, wherein
the first linear equalizer provided in the rth signal estimation unit performs a convolution operation as the first filter processing using a first filter coefficient and a second differential signal which is a difference between the first and second auxiliary signals generated by the r-1th signal estimation unit, and
the second linear equalizer provided in the rth signal estimation unit performs a convolution operation as the second filter processing using a second filter coefficient and a third differential signal which is a difference between the output of the first linear equalizer provided in the rth signal estimation unit and the plurality of received signals.

5. The signal estimation apparatus according to claim 1, wherein
a first linear equalizer of the two linear equalizers provided in the rth signal estimation unit performs a first filter processing using a first filter coefficient updated by a coefficient updating apparatus, and
a second linear equalizer of the two linear equalizers provided in the rth signal estimation unit performs a second filter processing using a second filter coefficient updated by the coefficient updating apparatus.

6. The signal estimation apparatus according to claim 5, wherein
the coefficient updating apparatus comprises a plurality of coefficient update error propagation units, the number of which is the same as the number of the plurality of signal estimation units, and
each of the plurality of coefficient update error propagation units updates an error signal which is a difference between estimation results of the plurality of transmitted signals by the signal estimation apparatus and correct values of the plurality of transmitted signals, and
a rth coefficient update error propagation unit among the plurality of coefficient update error propagation units, which updates first and second filter coefficients used by the rth signal estimation unit, updates the first and second filter coefficients by performing a linear operation of subtracting a result of a convolution operation using the output signals and an error signal updated by a r+1th coefficient update error propagation unit among the plurality of coefficient update error propagation units, which updates first and second filter coefficients used by a r+1th signal estimation unit, from the first and second filter coefficients before updating, and
the rth coefficient update error propagation unit updates the error signal by performing a convolution operation using the first and second filter coefficients, and performing a nonlinear conversion equivalent to a differentiation process of a nonlinear conversion performed by the nonlinear converter by using the result of the convolution operation.

7. The signal estimation apparatus according to claim 5, wherein
the coefficient updating apparatus updates the first filter coefficient from estimation results of the plurality of transmitted signals by the signal estimation apparatus and the plurality of received signals, using a method of estimating an impulse response of a transmission path by a least squares method, and
the coefficient updating apparatus generates a second matrix from a first matrix having element of the first filter coefficient and a predetermined numerical parameter, acquired by adding the numerical parameters to diagonal element of a product matrix of the first matrix and a conjugate arrangement matrix of the first matrix, and updates the second filter coefficient by calculating element of a product matrix of the first matrix and an inverse matrix of the second matrix as the second filter coefficient.

8. A signal estimation method for estimating a plurality of transmitted signals respectively corresponding to a plurality of received signals that are spatially multiplexed, from the plurality of received signals, the signal estimation method comprising:
inputting the plurality of received signals; and
estimating the plurality of transmitted signals from the plurality of received signals using a plurality of signal estimation units connected in series,
each of the plurality of signal estimation units comprising two linear equalizers and one nonlinear converter that performs nonlinear conversion, and
the estimating the plurality of transmitted signals comprises:
inputting output signals generated by a i-1th signal estimation unit (here, i is a variable indicating an integer equal to or greater than 2 and less than the number of signal estimation units) using the two linear equalizers and the nonlinear converter provided in the i-1th signal estimation unit to a ith signal estimation unit connected subsequent to the i-1th signal estimation unit; and
generating output signals to be output by the ith signal estimation unit by using the two linear equalizers and the nonlinear converter provided in the ith signal estimation unit, from the plurality of received signals and the output signals generated by the i-1-th signal estimation unit using the two linear equalizers and the nonlinear converter provided in the i-1-th signal estimation unit.

9. A non-transitory recording medium on which a computer program is stored, the computer program being configured to allow a computer to execute a signal estimation method for estimating a plurality of transmitted signals respectively corresponding to a plurality of received signals that are spatially multiplexed, from the plurality of received signals, the signal estimation method comprising:
inputting the plurality of received signals; and
estimating the plurality of transmitted signals from the plurality of received signals using a plurality of signal estimation units connected in series,
each of the plurality of signal estimation units comprising two linear equalizers and one nonlinear converter that performs nonlinear conversion, and
the estimating the plurality of transmitted signals comprises:
inputting output signals generated by a i-1th signal estimation unit (here, i is a variable indicating an integer equal to or greater than 2 and less than the number of signal estimation units) using the two linear equalizers and the nonlinear converter provided in the i-1th signal estimation unit to a ith signal estimation unit connected subsequent to the i-1th signal estimation unit; and
generating output signals to be output by the ith signal estimation unit by using the two linear equalizers and the nonlinear converter provided in the ith signal estimation unit, from the plurality of received signals and the output signals generated by the i-1-th signal estimation unit using the two linear equalizers and the nonlinear converter provided in the i-1-th signal estimation unit.
